(19) United States
(12) Patent Application Publication
(10) Pub. No.: US 2015/0259563 A1
(43) Pub. Date: Sep. 17, 2015

(54) WATER-BASED POLYPROPYLENE COATING HAVING WATER RESISTANCE

(71) Applicants: Michelle Ann Ibanez, Cincinnati, OH (US); Vincent S. Zabrocki, Maineville, OH (US)

(72) Inventors: Michelle Ann Ibanez, Cincinnati, OH (US); Vincent S. Zabrocki, Maineville, OH (US)

(21) Appl. No.: 14/659,826

(22) Filed: Mar. 17, 2015

Related U.S. Application Data
(60) Provisional application No. 61/954,185, filed on Mar. 17, 2014.

(51) Int. Cl. C09D 151/06; C08K 5/07; C08K 5/17; B32B 27/32; B32B 15/085; B32B 27/08; B32B 15/20; C08K 5/09; B65D 65/40

(52) U.S. Cl. CPC C09D 151/06; C08K 5/09; C08K 5/07; C08K 5/17; B65D 65/40; B32B 15/085; B32B 27/08; B32B 15/20; B32B 27/32; B32B 2255/06; B32B 2255/26; B32B 2255/10; B32B 2307/31; B32B 2553/00; B32B 2307/518

(57) ABSTRACT

Water-based coating compositions, coated substrates, and methods for adhering a polypropylene layer to a substrate. The coating compositions include a C₂-C₃ maleated polyolefin, a non-ionic surfactant, an anionic surfactant, and an amine. The coated substrate includes a substrate, a water-based coating composition applied on the substrate, and a polypropylene layer applied on the water-based coating composition. The methods include providing a substrate, applying a water-based coating composition to the substrate, and applying a polypropylene layer to the water-based coating composition, wherein the water-based coating composition enhances adhesion of the polypropylene layer to the substrate.

### CROSS REFERENCE TO RELATED APPLICATIONS

This application claims priority under 35 U.S.C. §119 to U.S. Provisional Patent Application No. 61/954,185, filed Mar. 17, 2014, entitled “Water-Based Polypropylene Coating Having Water Resistance” (Docket MIH 0106 MA/40504.199), the contents of which are hereby incorporated by reference in their entirety.

### TECHNICAL BACKGROUND

The present specification relates generally to coating compositions. More specifically, the present specification relates to water-based coating compositions for adhering a polypropylene layer to a substrate, to coated substrates, and to methods of adhering a polypropylene layer to a substrate.

### BACKGROUND

In the packaging industry, heat-sealable films are often employed. By way of example, polypropylene films are often heat sealed to substrates for use in the flexible food packaging and/or flexible medical packaging industries. However, because such polypropylene films generally exhibit poor heat sealing characteristics, coating compositions are typically employed to adhere and heat seal the polypropylene films to the substrates. While several such coating compositions are known, they possess several disadvantages and limitations. For example, some coating compositions are solvent based, and thus may be hazardous. Additionally, some coating compositions are useful only with co-extruded polypropylene resins, which may be expensive to produce. Accordingly, additional embodiments of coating compositions for adhering polypropylene layers to substrates are desired.

### SUMMARY

According to one or more embodiments, a water-based coating composition for adhering a polypropylene layer to a substrate is disclosed. The water-based coating includes a C₂-C₃ maleated polyolefin, a non-ionic surfactant, an anionic surfactant, and an amine. The water-based coating composition enhances adhesion of the polypropylene layer to the substrate upon application therebetween.

In other embodiments, a coated substrate is disclosed. The coated substrate includes a substrate having surfaces, a water-based coating composition applied to at least one of the surfaces of the substrate, and a polypropylene layer applied to the water-based coating composition. The water-based coating composition includes a C₂-C₃ maleated polyolefin, a non-ionic surfactant, an anionic surfactant, and an amine. The water-based coating composition applied to the surfaces of the substrate enhances adhesion of the polypropylene layer to the substrate.

In still other embodiments, a method of adhering a polypropylene layer to a substrate is disclosed. The method includes providing the substrate, wherein the substrate has surfaces, applying a water-based coating composition to at least one of the surfaces of the substrate, and applying the polypropylene layer to the water-based coating composition. The water-based coating composition includes a C₂-C₃ maleated polyolefin, a non-ionic surfactant, an anionic surfactant, and an amine. The water-based coating composition enhances adhesion between the polypropylene layer and the substrate.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### DETAILED DESCRIPTION

The following terms are used in the present application:

As used herein, the term “water-based” describes a water content of at least 60% by weight of a coating composition. In some embodiments, the water content is from about 60% to about 80% by weight of the coating composition, or from about 65% to about 75% by weight of the coating composition, or from about 70% to about 74% by weight of the coating composition, or about 72% by weight of the coating composition.

As used herein, the terms “adhesion” “adhesive” and/or “adhere” describe the bond strength and/or permanence of attachment of a polypropylene layer to a substrate via a coating composition. In some embodiments, adhesion is determined via seal strength testing, including both dry and wet seal strength testing. Wet seal strength testing may be a measure of how resistant performance of a coating composition is to sustained contact with water.

As used herein, the term “polypropylene layer” describes a layer including a polypropylene, a polypropylene copolymer, and combinations thereof. The polypropylene in the layer may be unbranched and/or branched. For example, the polypropylene layer includes a polypropylene homopolymer, a polypropylene blend, and/or a polypropylene in combination with a thermoplastic polyolefin. In embodiments, the polypropylene layer includes a cast film of polypropylene, an extruded polypropylene resin, and/or a thermoplastic polyolefin.

As used herein, the term “C₂-C₃ maleated polyolefin” describes a maleated polypropylene, a maleated polyethylene, and/or a maleated ethylene/propylene copolymer. For example, the C₂-C₃ maleated polyolefin includes a polypropylene, a polyethylene, and/or a ethylene/propylene copolymer having maleic anhydride groups grafted and/or attached thereon.

In the context of coating compositions, as used herein, the term “enhance” describes an increase in the adhesion and/or seal strength (including both dry and wet) of a polypropylene layer to a substrate relative to comparative compositions. For example, in the context of coating compositions, the wet seal strength of a polypropylene layer adhered and/or heat-sealed to a substrate with coating composition 1 was about 412 g/in, whereas the wet seal strength of a polypropylene layer adhered to and/or heat-sealed to a substrate with a comparative coating composition was about 67 g/in. Thus, adhesion and/or seal strength of the polypropylene layer to the substrate was enhanced in the presence of coating composition 1 (relative to comparative coating composition 1).

As used herein, the term “primer” describes a coating composition having a coat weight of from about 0.1 g/m² to about 5 g/m², or from about 0.2 g/m² to about 3 g/m², or from about 0.5 g/m² to about 1.5 g/m², or about 1 g/m².

### I. Water-Based Coating Compositions

Reference will now be made in detail to embodiments of water-based coating compositions for adhering a polypropylene layer to a substrate. In some embodiments, the water-based coating composition includes a C₂-C₃ maleated polyolefin, a non-ionic surfactant, an anionic surfactant, and an amine. The water-based coating composition enhances adhesion of the polypropylene layer to the substrate upon application therebetween.

In embodiments, the coating composition includes a C₂-C₃ maleated polyolefin. In embodiments, the C₂-C₃ maleated polyolefin is selected from a maleated polypropylene, a maleated polyethylene, and combinations thereof. In some embodiments, the coating composition includes a maleated polypropylene. In some embodiments, the maleated polypropylene has the following formula:

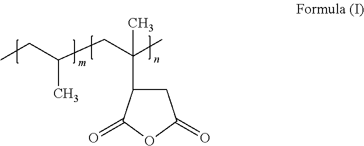

Referencing Formula (I), the maleated polypropylene includes a propylene polymer with maleic anhydride groups grafted and/or attached thereon. In some embodiments, the propylene polymer includes from about 5% to about 10% by weight of maleic anhydride groups per propylene polymer molecule. In other embodiments, the maleated polypropylene includes from about 6% to about 9%, or from about 8% to about 10%, or about 7% by weight of maleic anhydride groups per propylene polymer. In one or more embodiments, the maleated polypropylene has a weight average molecular weight of greater than about 9,000, as determined by gel permeation chromatography (hereinafter, “GPC”). In other embodiments, the maleated polypropylene has a weight average molecular weight of greater than about 9,100, as determined by GPC. In the context of the coating composition, the maleated polypropylene may function as a coupling agent.

The maleated polypropylene is present in the coating composition from about 15% to about 25%, or from about 17% to about 23%, or from about 19% to about 21%, or at about 20% by weight of the coating composition. In some embodiments, the maleated polypropylene includes a combination of propylene polymers with maleic anhydride groups grafted therein, as previously described herein. For example, the maleated polypropylene may include a propylene polymer including about 5% by weight of maleic anhydride groups per propylene polymer molecule in combination with a propylene polymer including about 10% by weight of maleic anhydride groups per propylene polymer.

In embodiments, the coating composition includes a maleated polyethylene. In some embodiments, the maleated polyethylene has the following formula:

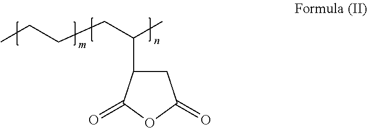

Referencing Formula (II), the maleated polyethylene includes a polyethylene polymer with maleic anhydride groups grafted and/or attached thereon. In some embodiments, the polyethylene polymer includes from about 0.1% to about 5% by weight of maleic anhydride groups per polyethylene polymer molecule. In other embodiments, the maleated polyethylene includes from about 0.2% to about 3%, or from about 0.3% to about 2%, or about 0.5% by weight of maleic anhydride groups per ethylene polymer. In the context of the coating composition, the maleated polyethylene may function as a coupling agent.

The maleated polyethylene is present in the coating composition from about 15% to about 25%, or from about 17% to about 23%, or from about 19% to about 21%, or at about 20% by weight of the coating composition. In some embodiments, the maleated polyethylene includes a combination of ethylene polymers with maleic anhydride groups grafted therein, as previously described herein. For example, the maleated polyethylene may include an ethylene polymer including about 0.5% by weight of maleic anhydride groups per ethylene polymer molecule in combination with an ethylene polymer including about 1% by weight of maleic anhydride groups per ethylene polymer.

The coating composition also includes a non-ionic surfactant. In some embodiments, the non-ionic surfactant is a C₁₁-C₁₅ secondary alcohol ethoxylate. The C₁₁-C₁₅ secondary alcohol ethoxylate may have the following formula:

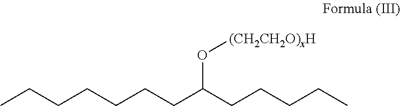

wherein:

the alkyl carbon chain length is from 11 to 15 (and not necessarily limited to the carbon chain length shown in Formula (III)); and

x is from 3 to 40.

C₁₁-C₁₅ secondary alcohol ethoxylates are generally formed from the reaction of alcohols with ethylene oxide under basic conditions. Referencing Formula (III), the C₁₁-C₁₅ secondary alcohol ethoxylate is a secondary alcohol having a C₁₁-C₁₅ alkyl chain, wherein varying numbers of ethylene oxide (i.e., ethoxylate) groups are grafted thereto. In some embodiments, the C₁₁-C₁₅ secondary alcohol ethoxylate includes from about 3 to about 40 ethoxylate groups per C₁₁-C₁₅ secondary alcohol ethoxylate molecule. In other embodiments, the C₁₁-C₁₅ secondary alcohol ethoxylate includes from about 5 to about 35, or from about 10 to about 30, or from about 15 to about 25, or from about 20 to 25 ethoxylate groups per C₁₁-C₁₅ secondary alcohol ethoxylate molecule. In one particular embodiment, the C₁₁-C₁₅ secondary alcohol ethoxylate includes about 9 ethoxylate groups per C₁₁-C₁₅ secondary alcohol ethoxylate molecule. With regard to Formula (III), the variable x corresponds to the number of ethoxylate groups per C₁₁-C₁₅ secondary alcohol ethoxylate molecule. In one or more embodiments, the C₁₁-C₁₅ secondary alcohol ethoxylate molecule is marketed under the tradename Tergitol™ 15-S. Additionally, in some embodiments, the non-ionic surfactant is free of alkyl phenol ethoxylates.

In some embodiments, the non-ionic surfactant is a nonylphenol ethoxylate. The nonylphenol ethoxylate may have the following formula:

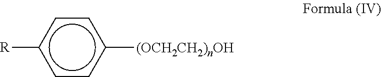

wherein:

R is a branched C₉H₁₉ depicted by the following formula:

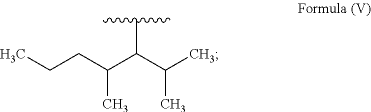 [SMILES: *C(C(C)C)C(C)CCC]

and

n is from 9 to 50.

Nonylphenol ethoxylates are formed from the reaction of nonylphenol and ethylene oxide with potassium hydroxide as a catalyst. Referencing Formula (IV), the nonylphenol ethoxylate is an ethoxylate having a branched C₉ alkyl chain, wherein varying numbers of ethylene oxide (i.e., ethoxylate) groups are grafted thereto. With regard to Formula (IV), the variable n corresponds to the number of ethoxylate groups per C₁₁-C₁₅ secondary alcohol ethoxylate molecule. In one or more embodiments, the nonylphenol ethoxylate molecule is marketed under the tradename Tergitol® NP.

The non-ionic surfactant is present in the coating composition from about 0.1% to about 5%, or from about 0.5% to about 3%, or from about 1% to about 3%, or at about 2% by weight of the coating composition. In some embodiments, the non-ionic surfactant includes a combination of C₁₁-C₁₅ secondary alcohol ethoxylate(s) and nonylphenol ethoxylate(s), as previously described herein. In the context of the coating composition, the non-ionic surfactant may function as an emulsion stabilizer.

The coating composition additionally includes an anionic surfactant. In some embodiments, the anionic surfactant is a C₁₆-C₁₈ saturated fatty acid. More particularly, in one or more embodiments, the anionic surfactant is a C₁₆-C₁₈ saturated carboxylic acid with a saturated C₁₆-C₁₈ chain. In one particular embodiments, the C₁₆-C₁₈ saturated fatty acid is a C₁₈ saturated fatty acid, such as, e.g., stearic acid. In other embodiments, the C₁₆-C₁₈ saturated fatty acid is a C₁₆ saturated fatty acid, such as, e.g., palmitic acid or oleic acid.

The anionic surfactant is present in the coating composition from about 1% to about 8%, or from about 2% to about 6%, or from about 3% to about 5%, or at about 4% by weight of the coating composition. In some embodiments, the anionic surfactant includes a combination of C₁₆-C₁₈ saturated fatty acids, as previously described herein. In the context of the coating composition, the anionic surfactant may function as an emulsion stabilizer.

The coating composition also includes an amine. In some embodiments, the amine is an alkanolamine. More specifically, the amine is an alkanolamine having a hydroxy group and an amino group on an alkane backbone. In some embodiments, the alkane backbone includes a C₂-C₈ chain. In further embodiments, the alkanolamine is dimethylethanolamine. In other embodiments, the alcohol amine is diethylethanolamine.

The amine is present in the coating composition from about 0.1% to about 5%, or from about 0.5% to about 3%, or from about 1% to about 3%, or about 2% by weight of the coating composition. In some embodiments, the amine includes a combination of alkanolamines, as previously described herein. In the context of the coating composition, the amine may function as an emulsion stabilizer.

In one or more embodiments, the coating composition may also include at least one preservative. In some embodiments, the preservative includes, but should not be limited to, 1, 2-benzisothiazolin-3-one, formalin, and combinations thereof. The preservative may be present in the coating composition from about 0.1% to about 1%, or from about 0.2% to about 0.8%, or at about 0.5% by weight of the coating composition. The preservative may function to prevent decomposition and/or undesirable chemical changes of the coating composition.

In some embodiments, a coating composition for adhering a polypropylene layer to a substrate is provided. The coating composition includes from about 15% to about 25% by weight of a C₂-C₃ maleated polyolefin, from about 1% to about 3% by weight of a non-ionic surfactant, from about 4% to about 8% of an anionic surfactant, and from about 1% to about 3% of an amine. The C₂-C₃ maleated polyolefin, non-ionic surfactant, anionic surfactant, and amine may be as previously described. In embodiments, the coating composition includes includes from about 15% to about 25% by weight of a maleated polypropylene, from about 1% to about 3% by weight of a non-ionic surfactant, from about 4% to about 8% of an anionic surfactant, and from about 1% to about 3% of an amine. The maleated polypropylene, non-ionic surfactant, anionic surfactant, and amine may be as previously described.

The water-based coating compositions described herein enhance adhesion of a polypropylene layer to a substrate upon application therebetween. The coating compositions may be applied to surfaces of a polypropylene layer and/or a substrate. In some embodiments, the water-based coating compositions described herein are primers. In further embodiments, the water-based coating compositions described herein are ink receptive primers (such as, e.g., for a polypropylene layer, including, e.g., a thermoplastic polyolefin layer), primers for ultraviolet/electron beam coatings (such as, e.g., for a polypropylene layer, including, e.g., a thermoplastic polyolefin layer), and/or paint primers.

In one or more embodiments, application and/or heat sealing of the coating compositions to surfaces of a polypropylene layer and/or a substrate provide a seal strength, i.e., a dry and/or wet seal strength, of at least 200 g/in. In other embodiments, the coating compositions provide a seal strength, i.e., a dry and/or wet seal strength, of at least 400 g/in. In some embodiments, the coating compositions provide a seal strength, i.e., a dry and/or wet seal strength, of from about 200 g/in to about 800 g/in, or from about 400 g/in to about 600 g/in, or about 500 g/in.

Embodiments of water-based coating compositions have been described in detail. Further embodiments directed to coated substrates will now be described.

### II. Coated Substrates

In one or more embodiments, the coated substrate includes a substrate having surfaces, a water-based coating composition applied to at least one of the surfaces of the substrate, and a polypropylene layer applied to the water-based coating composition. In some embodiments, the water-based coating composition includes a C₂-C₃ maleated polyolefin, a non-ionic surfactant, an anionic surfactant, and an amine. The water-based coating composition applied to the surfaces of the substrate enhances adhesion of the polypropylene layer to the substrate.

The coated substrate includes a substrate. In one or more embodiments, the substrate is a metalized substrate. In some embodiments, the substrate is a metalized substrate comprising one or more metals selected from the group consisting of zinc, iron, nickel, copper, silver, platinum, gold, and/or aluminum. In one embodiment, the substrate is an aluminum substrate. In a further embodiment, the substrate is an aluminum foil substrate.

In other embodiments, the substrate is a polypropylene substrate. In one particular embodiment, the substrate is a biaxially oriented polypropylene (hereinafter, “BOPP”) substrate. Biaxially oriented polypropylene substrates may be formed by biaxially extruding and stretching polypropylene film (such as, e.g., in both a machine direction and a cross machine direction).

In still other embodiments, the substrate is a paper substrate. In one particular embodiment, the substrate is an office paper substrate. In a further embodiment, the substrate is a white office paper substrate.

The coated substrate also includes a water-based coating composition applied to at least one of the surfaces of the substrate. In some embodiments, the coating composition is applied to at least one of the surfaces of the polypropylene layer. The coating composition may include a C₂-C₃ maleated polyolefin, a non-ionic surfactant, an anionic surfactant, and an amine, as previously described. However, the coating composition may also include any combination of components as previously described.

The coated substrate includes a polypropylene layer applied to the water-based coating. In some embodiments, the polypropylene layer is a cast film of polypropylene. In other embodiments, the polypropylene layer is an extruded polypropylene resin, e.g., a polypropylene homopolymer and/or a blend with up to 20% low density polypropylene (i.e., LDPE) for better processability through an extruder. In further embodiments, the polypropylene layer is an extruded polypropylene resin comprising a polypropylene blend having about 80% by weight polypropylene and about 20% by weight low density polypropylene. In embodiments, the polypropylene layer is a thermoplastic polyolefin. The thermoplastic polyolefin may be rigid or soft. In further embodiments, the thermoplastic polyolefin is a blend of polypropylene with elastic ethylene copolymers (e.g., polyolefin elastomers or POEs) along with fillers and/or additives. The polypropylene in the thermoplastic polyolefin may include a polypropylene homopolymer (such as, e.g., branched or unbranched) and/or a polypropylene copolymer (such as, e.g., branched or unbranched). The elastic ethylene copolymer in the thermoplastic polyolefin may include an ethylene propylene rubber, an ethylene propylene-diene rubber, an ethylene-octene, an ethylbenzene, and/or a styrene-ethylene-butadiene-styrene. Suitable thermoplastic polyolefins are known to those of ordinary skill in the art.

The water-based coating is applied to the substrate and/or the polypropylene layer such that it is in between the substrate and the polypropylene layer. In some embodiments, the water-based coating is sandwiched between the substrate and the polypropylene layer.

Embodiments of coated substrates have been described in detail. Further embodiments directed to methods of adhering a polypropylene layer to a substrate will now be described.

### III. Methods of Adhering a Polypropylene Layer to a Substrate

In some embodiments, the method of adhering a polypropylene layer to a substrate includes providing the substrate, wherein the substrate has surfaces, applying a water-based coating composition to at least one of the surfaces of the substrate, and applying the polypropylene layer to the water-based coating composition. The water-based coating composition includes a C₂-C₃ maleated polyolefin, a non-ionic surfactant, an anionic surfactant, and an amine. The water-based coating composition enhances adhesion between the polypropylene layer and the substrate. The substrate, water-based coating composition, and polypropylene layer are as previously described.

The water-based coating composition is applied to at least one of the surfaces of the substrate. The water-based coating composition may be applied via application techniques known to those of skill in the art. For example, in one embodiment, the water-based coating composition is manually applied to the substrate via use of a Mayer rod.

The water-based coating composition is applied the substrate in an amount sufficient to enhance adhesion between the polypropylene layer and the substrate. For example, in some embodiments, from about 0.3 grams to about 5 grams, or from about 0.5 grams to about 3 grams, or about 1 gram of the water-based coating composition per square inch of the substrate is applied to the substrate.

It should now be understood that various aspects of the water-based coating compositions, coated substrates, and methods for adhering a polypropylene layer to a substrate are described herein and that such aspects may be utilized in conjunction with various other aspects.

In a first aspect, the disclosure provides a water-based coating composition for adhering a polypropylene layer to a substrate. The water-based coating composition includes a C₂-C₃ maleated polyolefin, a non-ionic surfactant, an anionic surfactant, and an amine, in which the water-based coating composition enhances adhesion of the polypropylene layer to the substrate upon application therebetween.

In a second aspect, the disclosure provides a water-based coating composition of the first aspect, in which the C₂-C₃ maleated polyolefin is a maleated polypropylene.

In a third aspect, the disclosure provides a water-based coating composition of the second aspect, in which the maleated polypropylene polymer has a weight average molecular weight of greater than about 9,000.

In a fourth aspect, the disclosure provides a water-based coating composition of the second or the third aspect, in which the maleated polypropylene includes a combination of maleic anhydride grafted polypropylenes.

In a fifth aspect, the disclosure provides a water-based coating composition of the second or the third aspect, in which the maleated polypropylene is a maleic anhydride grafted polypropylene.

In a sixth aspect, the disclosure provides a water-based coating composition of the fifth aspect, in which the maleic anhydride grafted polypropylene includes from about 5% to about 10% by weight of maleic anhydride groups.

In a seventh aspect, the disclosure provides a water-based coating composition of the fifth or the sixth aspect, in which the maleic anhydride grafted polypropylene includes from about 8% to about 10% by weight of maleic anhydride groups.

In an eighth aspect, the disclosure provides a water-based coating composition of the first aspect, in which the C₂-C₃ maleated polyolefin is a maleated polyethylene.

In a ninth aspect, the disclosure provides a water-based coating composition of the eighth aspect, in which the maleated polyethylene is a maleic anhydride grafted polyethylene.

In a tenth aspect, the disclosure provides a water-based coating composition of the ninth aspect, in which the maleic anhydride grafted polyethylene includes about 0.5% by weight of the maleic anhydride groups.

In an eleventh aspect, the disclosure provides a water-based coating composition of any of the first to the tenth aspects, in which the non-ionic surfactant is selected from a C₁₁-C₁₅ secondary alcohol ethoxylate, a nonylphenol ethoxylate, and combinations thereof.

In a twelfth aspect, the disclosure provides a water-based coating composition of any of the first to the eleventh aspects, in which the non-ionic surfactant is a C₁₁-C₁₅ secondary alcohol ethoxylate including from about 3 to about 40 ethoxylate groups per C₁₁-C₁₅ secondary alcohol ethoxylate molecule.

In a thirteenth aspect, the disclosure provides a water-based coating composition of any of the first to the twelfth aspects, in which the non-ionic surfactant is a C₁₁-C₁₅ secondary alcohol ethoxylate including from about 5 to about 15 ethoxylate groups per C₁₁-C₁₅ secondary alcohol ethoxylate molecule.

In a fourteenth aspect, the disclosure provides a water-based coating composition of any of the first to the thirteenth aspects, in which the non-ionic surfactant is a C₁₁-C₁₅ secondary alcohol ethoxylate including about 9 ethoxylate groups per C₁₁-C₁₅ secondary alcohol ethoxylate molecule, and the non-ionic surfactant is substantially free of alkyl phenol ethoxylates.

In a fifteenth aspect, the disclosure provides a water-based coating composition of any of the first to the fourteenth aspects, in which the anionic surfactant is a C₁₆-C₁₈ saturated fatty acid.

In a sixteenth aspect, the disclosure provides a water-based coating composition of any of the first to the fifteenth aspects, in which the anionic surfactant is a C₁₈ saturated fatty acid.

In a seventeenth aspect, the disclosure provides a water-based coating composition of any of the first to the sixteenth aspects, in which the anionic surfactant is stearic acid.

In an eighteenth aspect, the disclosure provides a water-based coating composition of any of the first to the seventeenth aspects, in which the amine is an alkanolamine.

In a nineteenth aspect, the disclosure provides a water-based coating composition of the eighteenth aspect, in which the alkanolamine is dimethylethanolamine.

In a twentieth aspect, the disclosure provides a water-based coating composition of any of the first to the nineteenth aspects, in which the water-based coating composition includes: from about 15% to about 25% of the C₂-C₃ maleated polyolefin; from about 1% to about 3% of the non-ionic surfactant; from about 4% to about 8% of the anionic surfactant; and from about 1% to about 3% of the amine.

In a twenty-first aspect, the disclosure provides a water-based coating composition of any of the first to the twentieth aspects, in which the water-based coating composition includes a preservative.

In a twenty-second aspect, the disclosure provides a water-based coating composition of the twenty-first aspect, in which the preservative is selected from 1,2-benzisothiazolin-3-one, formalin, and combinations thereof.

In a twenty-third aspect, the disclosure provides a water-based coating composition of any of the first to the twenty-second aspects, in which the water-based coating composition defines a wet seal strength of at least 400 g/in.

In a twenty-fourth aspect, the disclosure provides a coated substrate including: a substrate having surfaces; a water-based coating composition of any of the first to the twenty-third aspects applied to at least one of the surfaces of the substrate; and a polypropylene layer applied to the water-based coating composition, wherein the water-based coating composition enhances adhesion of the polypropylene layer to the substrate.

In a twenty-fifth aspect, the disclosure provides a coated substrate of the twenty-fourth aspect, in which the substrate includes at least one of a metalized substrate or a polypropylene substrate.

In a twenty-sixth aspect, the disclosure provides a coated substrate of the twenty-fourth or the twenty-fifth aspect, in which the substrate includes at least one of an aluminum substrate or a biaxially oriented polypropylene substrate; and the water-based coating composition includes: from about 15% to about 25% of the C₂-C₃ maleated polyolefin; from about 1% to about 3% of the non-ionic surfactant; from about 4% to about 8% of the anionic surfactant; and from about 1% to about 3% of the amine.

In a twenty-seventh aspect, the disclosure provides a coated substrate of any of the twenty-fourth to the twenty-sixth aspects, in which the polypropylene layer includes an extruded polypropylene resin having about 80% by weight polypropylene and about 20% by weight low density polyethylene.

In a twenty-eighth aspect, the disclosure provides a method of adhering a polypropylene layer to a substrate, the method including: providing the substrate, wherein the substrate has surfaces; applying a water-based coating composition of any of the first to the twenty-third aspects to at least one of the surfaces of the substrate; and applying the polypropylene layer to the water-based coating composition, wherein the water-based coating composition enhances adhesion between the polypropylene layer and the substrate.

In a twenty-ninth aspect, the disclosure provides a method of the twenty-eighth aspect, in which the water-based coating composition is a primer.

### EXAMPLES

The following non-limiting examples illustrate seal strength testing of various water-based coating compositions and comparative coating compositions.

### Example 1

### Dry and Wet Seal Strength of Water-Based Coating Composition 1 and Comparative Coating Composition 1

Experimental Protocol. The seal strengths of a coating composition and a comparative coating composition were studied. More particularly, the dry and wet seal strengths of a water-based coating composition and a comparative coating composition were studied. The coating composition employed is as set forth in Table 1 (below) and the comparative coating composition employed is as set forth in Table 2 (below).

TABLE 1
Coating Composition 1

| | | Weight |
|---|---|---|
| Component | Manufacturer | Percentage (%) |
| Water/Diluent (Soft Water) | N/A | 66.77 |
| Maleated Polypropylene | DuPont (Wilmington, | 21.5 |
| (Fusabond ® P353) | DE) | |
| Anionic Surfactant (Stearic | Emery Oleochemical | 6.4 |
| Acid) | (Cincinnati, OH) | |
| NonIonic Surfactant (Tergitol ® | Sigma-Aldrich | 1.4 |
| NP-9 Surfactant) | (Saint Louis, MO) | |
| NonIonic Surfactant | Rhodia Inc. | 1.4 |
| (IGEPAL CO-977) | (Cranbury, NJ) | |
| Amine (Dimethylethanolamine) | Nexio Solutions | 2.33 |
| | (Columbus, OH) | |
| Preservative (PROXEL ™ | Arch Chemicals, Inc. | 0.20 |
| GXL) | (Smyrna, GA) | |

TABLE 2
Comparative Coating Composition 1

| | | Weight |
|---|---|---|
| Component | Manufacturer | Percentage (%) |
| Water/Diluent (Soft Water) | N/A | 59.25 |
| Maleated Polypropylene | DuPont (Wilmington, | 28 |
| (Fusabond ® P353) | DE) | |
| NonIonic Surfactant (Stearyl | Sciencelab.com, Inc. | 2.8 |
| Alcohol) | (Houston, TX) | |
| NonIonic Surfactant (Gastal | FCI Technology | 4.2 |
| Sal-20C) | (Bessemer City, NC) | |
| Amine (Dimethylethanolamine) | Nexio Solutions | 5.6 |
| | (Columbus, OH) | |
| Preservative (ACTICIDE ® | Thor GmbH (Speyer, | 0.15 |
| MV) | Germany) | |

The coating compositions set forth in Tables 1-2 were respectively prepared by mixing the components thereof in a stirring vessel under heat and pressure. More specifically, each of the coating compositions set forth in Tables 1-2 were respectively prepared by mixing the components thereof in a stifling vessel under high temperature (about 160° C.) and pressure. Although Coating Composition 1 includes a maleated polypropylene, it is contemplated that coating compositions employing a maleated polyethylene and/or a maleated ethylene/propylene copolymer, such as, e.g., instead of the maleated polypropylene, would be similarly prepared.

Upon preparation of the coating compositions set forth in Tables 1-2, water-based coating composition 1 (2.0 grams dry) and comparative coating composition 1 (2.3 grams dry) were respectively applied to a surface of an aluminum foil substrate with a Mayer rod (RD Specialties, Inc., Webster, N.Y.). Upon application of the coating compositions to the aluminum foil substrates, the coated aluminum foil substrates were dried in a hot air oven at 105° C.

Cast polypropylene films were then heat sealed via placement of the coated aluminum foil substrates and the cast polypropylene film in a heat sealer (TS-12 Heat Sealer, Lako-Tool Innovative Packaging Solutions, Perrysburg, Ohio) for 1-2 seconds at 180° C. and 60 psi. Upon heat sealing, the heat-sealed coated aluminum foil substrates and polypropylene films were trimmed such that they contained an approximately 1 inch by 1 inch sealed region along with a 4 inch to seven inch long tab.

Next, with regard to dry seal strength, the dry seal strengths of the heat-sealed aluminum foil substrate coated with the water-based coating composition 1 or the comparative coating composition 1 were determined in accordance with ASTM Standard F88. More particularly, the dry seal strength of the heat-sealed coated aluminum foil substrate was determined with a Vantage 2 Tensile Tester (Thwing-Albert, West Berlin, N.J.) using MAP-3.0 software. The specific parameters to determine the dry seal strength were as follows: (1) sample width was 1 inch; (2) pre-peel distance was −0.5 inches; (3) peel distance was 2 inches; and (4) test speed was 12 inches/min. The heat-sealed coated aluminum foil substrate was clamped into a sampling area of the Vantage 2 Tensile Tester such that the sealed area was at a 90° angle relative to the clamp tabs of the Vantage 2 Tensile Tester. The dry seal strength of the coated aluminum foil substrate was determined in triplicate, in order to gauge repeatability and/or reproducibility. The average force of the three trials was reported where failure mode was peel; the highest force of the three trials was reported where failure mode was a break and/or tear in the aluminum foil substrate.

With regard to determining wet seal strength, the wet seal strengths of the heat-sealed aluminum foil substrates coated with the water-based coating composition 1 or the comparative coating composition 1 were determined in accordance with ASTM Standard F88. More particularly, the procedure as previously described with regard to determining dry seal strength was employed, except that the heat-sealed coated aluminum foil substrates and polypropylene films were subjected to water immersion for 24 hours in a vessel prior to testing in the Vantage 2 Tensile Tester.

Experimental Results. As set forth in Table 3 below, coating composition 1 exhibited good dry seal strength and enhanced dry seal strength relative to comparative coating composition 1. Additionally, as set forth in Table 4 below, coating composition 1 exhibited good wet seal strength and enhanced wet seal strength relative to comparative coating composition 1.

TABLE 3
Dry Seal Strength

| Coating Composition | Dry Seal Strength (g/in) |
|---|---|
| Coating Composition 1 | 546 |
| Comparative Coating | 521 |
| Composition 1 | |

TABLE 4
Wet Seal Strength

| Coating Composition | Wet Seal Strength (g/in) |
|---|---|
| Coating Composition 1 | 412 |
| Comparative Coating | 67 |
| Composition 1 | |

### Example 2

### Seal Strength of Water-Based Coating Compositions 2-4

Experimental Protocol. The seal strengths of coating compositions 2-4 were studied. More particularly, the dry and wet seal strengths of coating compositions 2-4 were studied. The coating compositions employed are as set forth in Tables 5-7 (below).

TABLE 5
Coating Composition 2

| | | Weight |
|---|---|---|
| Component | Manufacturer | Percentage (%) |
| Water/Diluent (Soft Water) | N/A | 72.71 |
| Maleated Polypropylene | DuPont (Wilmington, | 16.48 |
| (Fusabond ® P353) | DE) | |
| Anionic Surfactant (Stearic | Emery Oleochemical | 6.18 |
| Acid) | (Cincinnati, OH) | |
| NonIonic Surfactant (Tergitol ® | Sigma-Aldrich | 2.34 |
| 15-S-9) | (Saint Louis, MO) | |
| Amine (Dimethylethanolamine) | Nexio Solutions | 2.09 |
| | (Columbus, OH) | |
| Preservative (Formalin, | UNIVAR USA | 0.2 |
| Formaldehyde, 37%) | (Sharonville, OH) | |

TABLE 6
Coating Composition 3

| | | Weight |
|---|---|---|
| Component | Manufacturer | Percentage (%) |
| Water/Diluent (Soft Water) | N/A | 74.82 |
| Maleated Polypropylene | DuPont (Wilmington, | 15.66 |
| (Fusabond ® P353) | DE) | |
| Maleated Polypropylene | Westlake Polymers | 0.84 |
| (Epolene ® Maleated | LLC (Houston, TX) | |
| Polypropylene Polymers E43) | | |
| Anionic Surfactant (Stearic | Emery Oleochemical | 4.94 |
| Acid) | (Cincinnati, OH) | |
| NonIonic Surfactant (Tergitol ® | Sigma-Aldrich | 1.87 |
| 15-S-9) | (Saint Louis, MO) | |
| Amine (Dimethylethanolamine) | Nexio Solutions | 1.67 |
| | (Columbus, OH) | |
| Preservative (Formalin | UNIVAR USA | 0.2 |
| Formaldehyde, 37%) | (Sharonville, OH) | |

TABLE 7
Coating Composition 4

| | | Weight |
|---|---|---|
| Component | Manufacturer | Percentage (%) |
| Water/Diluent (Soft Water) | N/A | 74.82 |
| Maleated Polypropylene | DuPont (Wilmington, | 15.66 |
| (Fusabond ® P353) | DE) | |
| Maleated Polypropylene | Westlake Polymers | 2.1 |
| (Epolene ® Maleated | LLC (Houston, TX) | |
| Polypropylene Polymers E43) | | |
| Anionic Surfactant (Stearic | Emery Oleochemical | 4.2 |
| Acid) | (Cincinnati, OH) | |
| NonIonic Surfactant (Tergitol ® | Sigma-Aldrich | 1.6 |
| 15-S-9) | (Saint Louis, MO) | |
| Amine (Dimethylethanolamine) | Nexio Solutions | 1.42 |
| | (Columbus, OH) | |
| Preservative (Formalin | UNIVAR USA | 0.2 |
| Formaldehyde, 37%) | (Sharonville, OH) | |

The coating compositions set forth in Tables 5-7 were respectively prepared by mixing the components thereof in a stirring vessel under heat and pressure. More specifically, each of the coating compositions set forth in Tables 5-7 were respectively prepared by mixing the components thereof in a stifling vessel under high temperature (about 160° C.) and pressure. Although Coating Compositions 2-4 include a maleated polypropylene, it is contemplated that coating compositions employing a maleated polyethylene and/or a maleated ethylene/propylene copolymer, such as, e.g., instead of the maleated polypropylene, would be similarly prepared.

Upon preparation of the coating compositions set forth in Tables 5-7, coating compositions 2-4 (1.6 grams dry) were respectively applied to a surface of a biaxially oriented polypropylene film substrate with a Mayer rod (RD Specialties, Inc., Webster, N.Y.). Heat sealing of cast polypropylene film to the coated surfaces of the biaxially oriented polypropylene film substrates was achieved via placement of the coated biaxially oriented polypropylene film substrate and cast polypropylene film in a heat sealer (TS-12 Heat Sealer, Lako-Tool Innovative Packaging Solutions, Perrysburg, Ohio) for 1-2 seconds at 180° C. and 60 psi. Upon heat sealing, the heat-sealed coated biaxially oriented polypropylene film substrates and polypropylene film were trimmed such that they contained an approximately 1 inch by 1 inch sealed region along with a 4 inch to seven inch long tab.

Next, with regard to dry seal strength, the dry seal strengths of the heat-sealed coated biaxially oriented polypropylene film substrates and polypropylene film were determined in accordance with ASTM Standard F88. More particularly, the dry seal strengths of the heat-sealed coated biaxially oriented polypropylene film substrates and polypropylene film were determined with a Vantage 2 Tensile Tester (Thwing-Albert, West Berlin, N.J.) using MAP-3.0 software. The specific parameters to determine the dry seal strength were as follows: (1) sample width was 1 inch; (2) pre-peel distance was -0.5 inches; (3) peel distance was 2 inches; and (4) test speed was 12 inches/min. The heat-sealed coated biaxially oriented polypropylene film substrates were clamped into a sampling area of the Vantage 2 Tensile Tester such that the sealed area was at a 90° angle relative to the clamp tabs of the Vantage 2 Tensile Tester. The dry seal strength of each of the coated biaxially oriented polypropylene film substrates was determined in triplicate, in order to gauge repeatability and/or reproducibility. The average force of the three trials was reported where failure mode was peel; the highest force of the three trials was reported where failure mode was a break and/or tear in the biaxially oriented polypropylene film substrate.

With regard to determining wet seal strength, the wet seal strengths of the heat-sealed aluminum foil substrates coated with the water-based coating compositions 2, 3, or 4 were determined in accordance with ASTM Standard F88. More particularly, the procedure as previously described with regard to determining dry seal strength was employed, except that the heat-sealed coated biaxially oriented polypropylene film substrates and polypropylene films were subjected to water immersion for 24 hours in a vessel prior to testing in the Vantage 2 Tensile Tester.

Experimental Results. As set forth in Table 8 below, coating compositions 2-4 exhibited good dry seal strength. Additionally, as set forth in Table 9 below, coating compositions 2-4 exhibited good wet seal strength.

TABLE 8
Dry Seal Strength

| Coating Composition | Dry Seal Strength (g/in) |
|---|---|
| Coating Composition 2 | 1082 |
| Coating Composition 3 | 1050 |
| Coating Composition 4 | 504 |

TABLE 9
Wet Seal Strength

| Coating Composition | Wet Seal Strength (g/in) |
|---|---|
| Coating Composition 2 | 424 |
| Coating Composition 3 | 348 |
| Coating Composition 4 | 205 |

### Example 3

### Dry and Wet Seal Strength of Water-Based Coating Composition 3 and Comparative Coating Compositions 2-3

Experimental Protocol. The seal strengths of coating composition 3 and comparative coating compositions 2-3 were studied. More particularly, the dry and wet seal strengths of water-based coating composition 3 and comparative coating compositions 2-3 were studied. Coating composition 3 is as previously set forth in Table 6 (above) and comparative coating compositions 2-3 are as set forth in Tables 10-11 (below).

TABLE 10
Comparative Coating Composition 2

| | | Weight |
|---|---|---|
| Component | Manufacturer | Percentage (%) |
| Deionized Water | N/A | 90 |
| Lupasol ® P (High Molecular | BASF USA | 10 |
| Weight Ethyleneimine | (Florham Park, | |
| Homopolymer) | NJ) | |

TABLE 11
Comparative Coating Composition 3

| | | Weight |
|---|---|---|
| Component | Manufacturer | Percentage (%) |
| NeoRez ® R-600 (Polyurethane | DSM (Heerlen, | 100 |
| Dispersion) | Netherlands) | |

Coating composition 3 was prepared as previously described. Comparative coating compositions 2-3 were also prepared. Upon preparation of coating composition 3 and comparative coating compositions 2-3, water-based coating composition 3 (2.0 grams dry) and comparative coating composition 2-3 (2.3 grams dry) were respectively applied to a surface of an aluminum foil substrate, a biaxially oriented polypropylene film substrate, or a paper substrate with a Mayer rod (RD Specialties, Inc., Webster, N.Y.). Upon application of the coating compositions to the substrates, the coated substrates were dried in a hot air oven at 105° C.

Cast polypropylene films were then heat sealed via placement of the coated substrates and the cast polypropylene film in a heat sealer (TS-12 Heat Sealer, Lako-Tool Innovative Packaging Solutions, Perrysburg, Ohio) for 1-2 seconds at 180° C. and 60 psi. Upon heat sealing, the heat-sealed coated substrates and polypropylene films were trimmed such that they contained an approximately 1 inch by 1 inch sealed region along with a 4 inch to seven inch long tab.

Next, with regard to dry seal strength, the dry seal strength of the heat-sealed coated substrates was determined in accordance with ASTM Standard F88. More particularly, the dry seal strength of the heat-sealed coated substrates was determined with a Vantage 2 Tensile Tester (Thwing-Albert, West Berlin, N.J.) using MAP-3.0 software. The specific parameters to determine the dry seal strength were as follows: (1) sample width was 1 inch; (2) pre-peel distance was -0.5 inches; (3) peel distance was 2 inches; and (4) test speed was 12 inches/min. The heat-sealed coated substrates were clamped into a sampling area of the Vantage 2 Tensile Tester such that the sealed area was at a 90° angle relative to the clamp tabs of the Vantage 2 Tensile Tester. The dry seal strength of the coated substrates was determined in triplicate, in order to gauge repeatability and/or reproducibility. The average force of the three trials was reported where failure mode was peel; the highest force of the three trials was reported where failure mode was a break and/or tear in the substrate.

With regard to determining wet seal strength, the wet seal strength of the heat-sealed coated aluminum and biaxially oriented polypropylene film substrates was determined in accordance with ASTM Standard F88. More particularly, the procedure as previously described with regard to determining dry seal strength was employed, except that the heat-sealed coated substrates were subjected to water immersion for 24 hours in a vessel prior to testing in the Vantage 2 Tensile Tester.

Experimental Results. As set forth in Tables 12-14 below, coating composition 3 exhibited good dry and wet seal strength. Additionally, as set forth in Table 12-15 below, coating composition 4 exhibited enhanced dry and wet seal strength relative to comparative coating compositions 2 and 3.

TABLE 12
Aluminum Foil Substrate

| | Dry Seal Strength | Wet Seal Strength |
|---|---|---|
| Coating Composition | (g/in) | (g/in) |
| Coating Composition 3 | 1050 | 348 |
| Comparative Coating | 266 | <20 |
| Composition 2 | | |
| Comparative Coating | <20 | <20 |
| Composition 3 | | |

TABLE 13
Biaxially Oriented Polypropylene Film Substrate

| | Dry Seal Strength | Wet Seal Strength |
|---|---|---|
| Coating Composition | (g/in) | (g/in) |
| Coating Composition 3 | 953 | 373 |
| Comparative Coating | 271 | <20 |
| Composition 2 | | |
| Comparative Coating | 272 | <20 |
| Composition 3 | | |

TABLE 14
Paper Substrate

| Coating Composition | Dry Seal Strength (g/in) |
|---|---|
| Coating Composition 3 | 302 |
| Comparative Coating | 158 |
| Composition 2 | |
| Comparative Coating | 80 |
| Composition 3 | |

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

It is noted that terms like “preferably,” “generally,” “commonly,” and “typically” are not utilized herein to limit the scope of the claims or to imply that certain features are critical, essential, or even important to the structure or function of the claims. Rather, these terms are merely intended to highlight alternative or additional features that may or may not be utilized in a particular embodiment of the present disclosure.

For the purposes of describing and defining the present disclosure it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

All documents cited are incorporated herein by reference; the citation of any document is not to be construed as an admission that it is prior art with respect to the present disclosure.

It is to be further understood that where descriptions of various embodiments use the term “comprising,” and/or “including” those skilled in the art would understand that in some specific instances, an embodiment can be alternatively described using language “consisting essentially of” or “consisting of.”

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Unless otherwise defined, all technical and scientific terms used herein have the same meaning as commonly understood by one of ordinary skill in the art to which the claimed subject matter belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

What is claimed is:

1. A water-based coating composition for adhering a polypropylene layer to a substrate, the water-based coating composition comprising:
(a) a C₂-C₃ maleated polyolefin;
(b) a non-ionic surfactant;
(c) an anionic surfactant; and
(d) an amine, wherein the water-based coating composition enhances adhesion of the polypropylene layer to the substrate upon application therebetween.

2. The water-based coating composition of claim 1, wherein the C₂-C₃ maleated polyolefin is a maleated polypropylene.

3. The water-based coating composition of claim 2, wherein the maleated polypropylene has a weight average molecular weight of greater than about 9,000.

4. The water-based coating composition of claim 2, wherein the maleated polypropylene comprises a combination of maleic anhydride grafted polypropylenes.

5. The water-based coating composition of claim 2, wherein the maleated polypropylene is a maleic anhydride grafted polypropylene.

6. The water-based coating composition of claim 5, wherein the maleic anhydride grafted polypropylene comprises from about 5% to about 10% by weight of maleic anhydride groups.

7. The water-based coating composition of claim 5, wherein the maleic anhydride grafted polypropylene comprises from about 8% to about 10% by weight of maleic anhydride groups.

8. The water-based coating composition of claim 1, wherein the C₂-C₃ maleated polyolefin is a maleated polyethylene.

9. The water-based coating composition of claim 8, wherein the maleated polyethylene is a maleic anhydride grafted polyethylene.

10. The water-based coating composition of claim 9, wherein the maleic anhydride grafted polyethylene comprises about 0.5% by weight of the maleic anhydride groups.

11. The water-based coating composition of claim 1, wherein the non-ionic surfactant is selected from the group consisting of a C₁₁-C₁₅ secondary alcohol ethoxylate, a nonylphenol ethoxylate, and combinations thereof.

12. The water-based coating composition of claim 11, wherein the non-ionic surfactant is a C₁₁-C₁₅ secondary alcohol ethoxylate comprising from about 3 to about 40 ethoxylate groups per C₁₁-C₁₅ secondary alcohol ethoxylate molecule.

13. The water-based coating composition of claim 11, wherein the non-ionic surfactant is a C₁₁-C₁₅ secondary alcohol ethoxylate comprising from about 5 to about 15 ethoxylate groups per C₁₁-C₁₅ secondary alcohol ethoxylate molecule.

14. The water-based coating composition of claim 1, wherein:
the non-ionic surfactant is a C₁₁-C₁₅ secondary alcohol ethoxylate comprising about 9 ethoxylate groups per C₁₁-C₁₅ secondary alcohol ethoxylate molecule; and
the non-ionic surfactant is substantially free of alkyl phenol ethoxylates.

15. The water-based coating composition of claim 1, wherein the anionic surfactant is a C₁₆-C₁₈ saturated fatty acid.

16. The water-based coating composition of claim 15, wherein the anionic surfactant is a C₁₈ saturated fatty acid.

17. The water-based coating composition of claim 16, wherein the anionic surfactant is stearic acid.

18. The water-based coating composition of claim 1, wherein the amine is an alkanolamine.

19. The water-based coating composition of claim 18, wherein the alkanolamine is dimethylethanolamine.

20. The water-based coating composition of claim 1, wherein the water-based coating composition comprises:
from about 15% to about 25% of the C₂-C₃ maleated polyolefin;
from about 1% to about 3% of the non-ionic surfactant;
from about 4% to about 8% of the anionic surfactant; and
from about 1% to about 3% of the amine.

21. The water-based coating composition of claim 1, further comprising a preservative.

22. The water-based coating composition of claim 21, wherein the preservative is selected from the group consisting of 1,2-benzisothiazolin-3-one, formalin, and combinations thereof.

23. The water-based coating composition of claim 1, wherein the water-based coating composition defines a wet seal strength of at least 400 g/in.

24. A coated substrate comprising:
(a) a substrate having surfaces;
(b) a water-based coating composition applied to at least one of the surfaces of the substrate, wherein the water-based coating composition comprises:
(1) a C₂-C₃ maleated polyolefin;
(2) a non-ionic surfactant;
(3) an anionic surfactant; and
(4) an amine; and
(c) a polypropylene layer applied to the water-based coating composition, wherein the water-based coating composition enhances adhesion of the polypropylene layer to the substrate.

25. The coated substrate of claim 24, wherein the substrate comprises at least one of a metalized substrate or a polypropylene substrate.

26. The coated substrate of claim 24, wherein:
the substrate comprises at least one of an aluminum substrate or a biaxially oriented polypropylene substrate; and
the water-based coating composition comprises:
from about 15% to about 25% of the C₂-C₃ maleated polyolefin, wherein the C₂-C₃ maleated polyolefin is a maleated polypropylene;
from about 1% to about 3% of the non-ionic surfactant;
from about 4% to about 8% of the anionic surfactant; and
from about 1% to about 3% of the amine.

27. The coated substrate of claim 24, wherein the polypropylene layer comprises an extruded polypropylene resin having about 80% by weight polypropylene and about 20% by weight low density polyethylene.

28. A method of adhering a polypropylene layer to a substrate, the method comprising:
(a) providing the substrate, wherein the substrate has surfaces;
(b) applying a water-based coating composition to at least one of the surfaces of the substrate, wherein the water-based coating composition comprises:
(1) a C₂-C₃ maleated polyolefin;
(2) a non-ionic surfactant;
(3) an anionic surfactant; and
(4) an amine; and
(c) applying the polypropylene layer to the water-based coating composition, wherein the water-based coating composition enhances adhesion between the polypropylene layer and the substrate.

29. The method of claim 28, wherein the water-based coating composition is a primer.
